(19) United States
(12) Patent Application Publication
(10) Pub. No.: US 2025/0252926 A1
(43) Pub. Date: Aug. 7, 2025

(54) GATE DRIVING CIRCUIT AND DISPLAY APPARATUS INCLUDING THE SAME

(71) Applicant: LG DISPLAY CO., LTD., Seoul (KR)

(72) Inventor: Min Su KIM, Paju-si (KR)

(73) Assignee: LG DISPLAY CO., LTD., Seoul (KR)

(21) Appl. No.: 18/828,489

(22) Filed: Sep. 9, 2024

(30) Foreign Application Priority Data
Feb. 5, 2024 (KR) 10-2024-0017750

(51) Int. Cl. G09G 3/3266; G09G 3/3275

(52) U.S. Cl. CPC G09G 3/3266; G09G 3/3275; G09G 2330/023

(57) ABSTRACT

Disclosed are a gate driving circuit and a display device including the same. The gate driving circuit includes a first controller configured to control the voltage of a set node, a second controller configured to control the voltage of a reset node, a first output transistor connected to the set node, and a second output transistor connected to the reset node.

### CROSS-REFERENCE TO RELATED APPLICATIONS

This application claims the benefit of Korean Patent Application No. 10-2024-0017750, filed on Feb. 5, 2024, which is hereby incorporated by reference as if fully set forth herein.

### TECHNICAL FIELD

The present disclosure relates to a display device, and more particularly, to a gate driving circuit and a display device including the same.

### BACKGROUND

Display devices that implement various pieces of information on a screen are core technology in the era of information and communications, and are being developed to be thinner, lighter, and more portable, and to have higher performance. Therefore, display devices capable of being manufactured in a lightweight and thin form are attracting attention.

Representative examples of display devices include a liquid crystal display (LCD) device, a quantum dot display (QDD) device, a field emission display (FED) device, and an organic light-emitting display (OLED) device.

Among these display devices, an OLED device has a self-emissive property, and is advantageous in terms of power consumption due to the low-voltage driving property thereof, and has a high response speed, high luminous efficiency, a wide viewing angle, and a high contrast ratio. Thus, the OLED device is currently being developed as a next-generation display device.

### SUMMARY

There are nodes on stages of a gate driving circuit, and in abnormal on/off situations, voltages of the nodes may be unstable, causing the gate driving circuit to malfunction.

Accordingly, the present disclosure is directed to a gate driving circuit and a display device including the same that substantially obviate one or more problems due to limitations and disadvantages of the related art.

The present disclosure provides a gate driving circuit and a display device including the same capable of preventing malfunction of the gate driving circuit using a reset signal even when an abnormal on/off situation occurs and thus voltages of nodes are unstable.

The object to be accomplished by the present disclosure is not limited to the above-mentioned objects, and other objects not mentioned herein will be clearly understood by those skilled in the art from the following description.

Additional advantages, objects, and features of the disclosure will be set forth in part in the description which follows and in part will become apparent to those having ordinary skill in the art upon examination of the following or may be learned from practice of the disclosure. The objects and other advantages of the disclosure may be realized and attained by the structure particularly pointed out in the written description and claims hereof as well as the appended drawings.

To achieve these objects and other advantages and in accordance with the purpose of the disclosure, as embodied and broadly described herein, a gate driving circuit includes a first controller configured to control the voltage of a set node, a second controller configured to control the voltage of a reset node, a first output transistor connected to the set node, and a second output transistor connected to the reset node.

In another aspect of the present disclosure, a gate driving circuit includes a first controller configured to control the voltage of a set node, a second controller configured to control the voltage of a reset node, a first reset transistor connected between a gate high voltage line and a Q2 node, a first output transistor connected to the set node, and a second output transistor connected to the reset node.

In still another aspect of the present disclosure, a display device includes a display panel including a plurality of data lines, a plurality of gate lines, and a plurality of pixels, a gate driving circuit connected to the plurality of gate lines, and a data driving circuit connected to the plurality of data lines. The gate driving circuit includes a first controller configured to control the voltage of a set node, a second controller configured to control the voltage of a reset node, a first output transistor connected to the set node, and a second output transistor connected to the reset node. The gate driving circuit according to another aspect includes a first controller configured to control the voltage of a set node, a second controller configured to control the voltage of a reset node, a first reset transistor connected between a gate high voltage line and a Q2 node, a first output transistor connected to the set node, and a second output transistor connected to the QB node.

It is to be understood that both the foregoing general description and the following detailed description of the present disclosure are exemplary and explanatory and are intended to provide further explanation of the disclosure as claimed.

### BRIEF DESCRIPTION OF THE DRAWINGS

The accompanying drawings, which are included to provide a further understanding of the disclosure and are incorporated in and constitute a part of this application, illustrate aspect(s) of the disclosure and together with the description serve to explain the principle of the disclosure. In the drawings:

FIG. 1 is a block diagram showing a display device according to an aspect of the present disclosure;

FIG. 2 is a circuit diagram of a pixel included in the display device according to an aspect of the present disclosure;

FIG. 3 is a cross-sectional view showing the display device according to an aspect of the present disclosure;

FIG. 4 is a diagram showing the configuration of a gate driving circuit according to an aspect of the present disclosure;

FIG. 5 is a waveform diagram of an emission driver in the gate driving circuit of the display device according to the aspect of the present disclosure;

FIG. 6 is a diagram showing the configuration of a gate driving circuit according to another aspect of the present disclosure; and

FIG. 7 is a waveform diagram of an emission driver in the gate driving circuit of the display device according to an aspect of the present disclosure.

### DETAILED DESCRIPTION

Hereinafter, exemplary aspects of the present disclosure will be described with reference to the accompanying drawings. Wherever possible, the same reference numerals will be used throughout the drawings to refer to the same or like parts.

In describing the present disclosure, when it is determined that a detailed description of a well-known technology associated with the present disclosure may unnecessarily make the gist of the present disclosure unclear, it will be omitted. In addition, the names of constituent elements used in the following description are selected in consideration of case of writing the specification and may differ from the names of parts of actual products.

In the drawings for explaining the exemplary aspects of the present disclosure, for example, the illustrated shape, size, ratio, angle, and number are given by way of example, and thus, are not limited to the disclosure. Throughout the present specification, the same reference numerals designate the same constituent elements.

In addition, in the following description of the present disclosure, a detailed description of known functions and configurations incorporated herein will be omitted when it may make the subject matter of the present disclosure rather unclear.

The terms “comprises”, “includes”, and/or “has”, used in this specification, do not preclude the presence or addition of other elements unless used along with the term “only”. The singular forms are intended to include the plural forms as well, unless the context clearly indicates otherwise.

In the interpretation of constituent elements included in various aspects of the present disclosure, the constituent elements are interpreted as including an error range even if there is no explicit description thereof.

In the description of the various aspects of the present disclosure, when describing positional relationships, for example, when the positional relationship between two parts is described using “on”, “above”, “below”, “next to”, or the like, one or more other parts may be located between the two parts unless the term “directly” or “closely” is used.

In the description of the various aspects of the present disclosure, when describing temporal relationships, for example, when the temporal relationship between two actions is described using “after”, “subsequently”, “next”, “before”, or the like, the actions may not occur in succession unless the term “directly” or “just” is used therewith.

It may be understood that, although the terms “first”, “second”, etc. may be used herein to describe various elements, these elements are not to be limited by these terms. These terms are merely used to distinguish one element from another. Therefore, in the present specification, an element indicated by “first” may be the same as an element indicated by “second” without exceeding the technical scope of the present disclosure, unless otherwise mentioned.

The respective features of the various aspects of the present disclosure may be partially or entirely coupled to or combined with each other, and various technical linkages and modes of operation thereof are possible. These various aspects may be performed independently of each other or may be performed in association with each other.

Hereinafter, a display device according to an aspect of the present disclosure will be described with reference to the accompanying drawings.

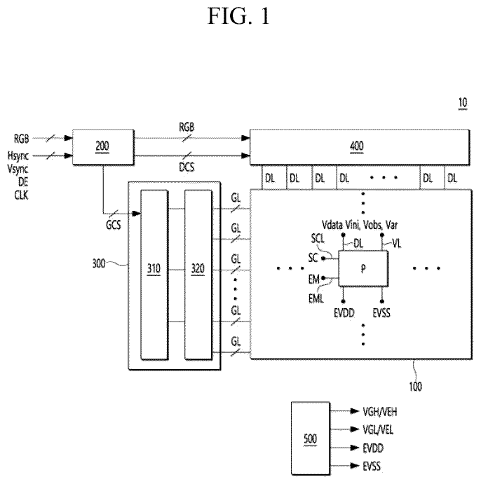

FIG. 1 is a block diagram showing a display device according to an aspect of the present disclosure.

As shown in FIG. 1, a display device according to an aspect of the present disclosure may include a display panel 100, a data driving circuit 400, a gate driving circuit 300, a power supply unit 500, and a timing controller 200.

A plurality of pixels P may be disposed on the display panel 100. The plurality of pixels P may be disposed in regions in which a plurality of data lines DL and a plurality of gate lines GL intersect each other. The pixels P disposed on the same horizontal line may constitute one pixel row. The pixels P disposed in one pixel row may be connected to one gate line GL, and one gate line GL may include at least one scan line and at least one emission line. For example, each pixel P may be connected to one data line DL, at least one scan line, and at least one emission line. However, the aspects of the present disclosure are not limited thereto.

The data driving circuit 400 may be connected to the data lines DL. The data driving circuit 400 may drive the data lines DL. The gate driving circuit 300 may be connected to the gate lines GL. The gate driving circuit 300 may drive the gate lines GL. The power generation unit 500 may supply power required to drive each of the plurality of pixels P.

The plurality of pixels P may commonly receive a high-potential driving voltage ELVDD and a low-potential driving voltage ELVSS from the power generation unit 500. The plurality of pixels P may receive a bias voltage Vobs and an initialization voltage Vini from a power line VL.

Thin film transistors (TFTs) included in each pixel P may be implemented as an oxide TFT including an oxide semiconductor layer. The oxide TFT may be advantageous in terms of enlargement of the display panel 100, taking into consideration electron mobility and process deviation. However, the aspects of the present disclosure are not limited thereto. The semiconductor layer of the TFT may be formed of amorphous silicon, polysilicon, or the like.

Each pixel P may include an organic light-emitting diode (OLED), a driving TFT configured to supply current to the organic light-emitting diode, a switching TFT configured to supply a data voltage to the driving TFT, and a storage capacitor configured to store the data voltage supplied to the driving TFT. The storage capacitor may maintain the data voltage during one frame.

Each pixel P may further include a plurality of TFTs and a storage capacitor to compensate for changes in a threshold voltage of the driving TFT.

A touch unit may be included in the display panel 100. The touch unit may include touch sensors. Touch input may be sensed using the touch sensors or through the pixels P. The touch sensors may be implemented as on-cell type or add-on type touch sensors. The touch sensors may be attached to a screen of the display panel, or may be implemented as in-cell type touch sensors and embedded (e.g., integral) in the display panel 100. However, the aspects aspects of the present disclosure are not limited thereto.

The timing controller 200 may control driving timing of the data driving circuit 400 and the gate driving circuit 300. The timing controller 200 may rearrange digital video data RGB thas is input from the outside based on the resolution of the display panel 100 and may supply the rearranged digital video data to the data driving circuit 400.

Further, the timing controller 200 may generate a data control signal DDC for control of operation timing of the data driving circuit 400 and a gate control signal GDC for control of operation timing of the gate driving circuit 300 based on timing signals, such as a vertical sync signal Vsync, a horizontal sync signal Hsync, a dot clock signal DCLK, and a data enable signal DE.

The timing controller 200 may multiply an input frame frequency by “i” and may control operation timing of a display panel driver at a frame frequency of “input frame frequency^{×}i” Hz (where i is a positive integer greater than 0). The input frame frequency may be 60 Hz in a national television standards committee (NTSC) system and may be 50 Hz in a phase-alternating line (PAL) system. However, the aspects of the present disclosure are not limited thereto.

The data driving circuit 400 may convert the digital video data RGB input from the timing controller 200 into an analog data voltage based on the data control signal DDC and may provide the analog data voltage to each of the data lines DL.

The data driving circuit 400 may include one or more source driver integrated circuits (ICs) SIC. The source driver ICs may convert digital video data of an input image into an analog gamma compensation voltage under the control of the timing controller 200 to generate a data voltage and may output the data voltage to the data lines DL. The source driver ICs may be mounted on a bendable flexible circuit board, e.g., a chip-on-film (COF), or may be directly adhered to a substrate in a non-active area of the display panel 100 through a COG process.

The COFs may be adhered to a pad area of the display panel 100 and a source PCB through an anisotropic conductive film (ACF). Input pins of the COFs may be electrically connected to output terminals (pads) of the source PCB. Output pins of the COFs may be electrically connected to data pads formed on the substrate of the display panel 100 through the ACF.

In another example, the driver ICs may be included in the display panel. For example, the driver ICs may be disposed in a chip-on-panel (COP) form.

Although one data driving circuit 400 is illustrated in FIG. 1 as being disposed on one side of the display panel 100, the number of data driving circuits 400 and the placement position thereof are not limited thereto. For example, the data driving circuit 400 may be composed of a plurality of ICs, and the plurality of ICs may be separately disposed on one side of the display panel 100.

The gate driving circuit 300 may generate a scan signal and an emission signal based on the gate control signal GDC. The gate driving circuit 300 may include at least one scan driver 310 and an emission driver 320.

The at least one scan driver 310 may generate a scan signal SC and supply the same to the gate lines GL in a row-sequential manner to drive at least one scan line SCL connected to each pixel row. The at least one scan driver 310 may output a scan pulse in response to a start pulse and a shift clock from the timing controller 200 and may shift the scan pulse according to a shift clock timing.

The emission driver 320 may generate an emission signal EM and may supply the same to the emission lines in a row-sequential manner to drive at least one emission line EML connected to each pixel row. The emission driver 320 may output an emission control signal pulse in response to a start pulse and a shift clock from the timing controller 200 and may sequentially shift the emission control signal pulse according to the shift clock.

The scan signal SC may include a scan pulse that swings between a gate-on voltage VGL and a gate-off voltage VGH. The emission control signal EM may include an emission control signal pulse that swings between a gate-on voltage VEL and a gate-off voltage VEH. The scan pulse may select pixels P of a line to which a data voltage Vdata is to be written. The emission control signal EM may define a light-emitting time of the pixels P.

The gate lines GL may supply a scan signal SC and an emission control signal EM to the plurality of pixels P, and the data lines DL may supply a data voltage Vdata to the plurality of pixels P. According to various aspects, the gate lines GL may include a plurality of scan lines SCL for supply of the scan signal SC and a plurality of emission control signal lines EML for supply of the emission control signal EM.

The power supply unit 500 may generate direct-current (DC) power required to drive the pixel array of the display panel 100 and the display panel driver using a DC-DC converter. The DC-DC converter may include a charge pump, a regulator, a buck converter, and a boost converter. However, the aspects of the present disclosure are not limited thereto.

The power supply unit 500 may receive a DC input voltage from a host system and may generate DC voltages, such as gate-on voltages VGL and VEL, gate-off voltages VGH and VEH, a high-potential driving voltage EVDD, and a low-potential driving voltage EVSS.

The gate-on voltages VGL and VEL and the gate-off voltages VGH and VEH may be supplied to a level shifter and the gate driving circuit 300. The high-potential driving voltage ELVDD and the low-potential driving voltage ELVSS may be commonly supplied to the pixels P.

The plurality of pixels P of the display panel 100 may include at least a first pixel, a second pixel, and a third pixel. The first pixel, the second pixel, and the third pixel may emit light of different colors. For example, the first pixel may be a red pixel, the second pixel may be a green pixel, and the third pixel may be a blue pixel.

The sizes of the plurality of pixels P may be identical to or different from each other. The sizes of the first pixel, the second pixel, and the third pixel may be designed to be different from each other in consideration of color balance or the lifespan of the OLED included in each of the first pixel, the second pixel, and the third pixel.

To implement lower power consumption, the display device according to the present disclosure may employ variable refresh rate (VRR) technology that varies a driving frequency.

For example, the timing controller 200 may generate signals so that the pixels P may be driven at various refresh rates. For example, the timing controller 200 may generate driving-related signals so that the pixels P may be driven in a VRR mode or to be switchable between a first refresh rate and a second refresh rate. For example, the timing controller 200 may change a speed of the clock signal, may generate a synchronization signal to generate a horizontal blank or a vertical blank, or may drive the gate driving circuit 300 in a mask manner, thereby driving the pixels P at various refresh rates.

Therefore, to vary the driving frequency, it is necessary to perform driving in an anode reset frame. To perform driving in the anode reset frame, each pixel may be configured to supply an anode reset voltage VAR.

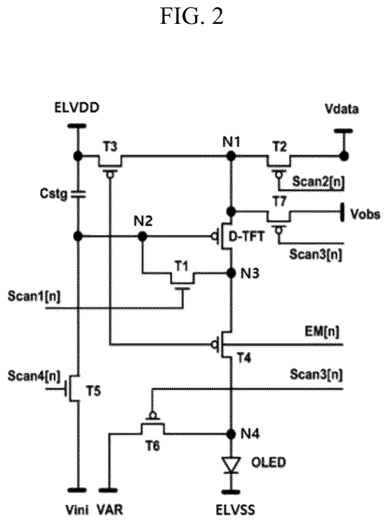

FIG. 2 is a circuit diagram of a pixel included in the display device according to the aspect of the present disclosure.

As shown in FIG. 2, each pixel P may include a pixel driving circuit and an emission unit.

The pixel driving circuit may include first to seventh transistors T1 to T7, a storage capacitor Cstg, and a driving transistor D-TFT. The emission unit may include an organic light-emitting diode OLED.

The first to seventh transistors T1 to T7 and the driving transistor D-TFT may be implemented as different types of transistors. For example, one transistor among the first to seventh transistors T1 to T7 and the driving transistor D-TFT may be a transistor using an oxide semiconductor as an active layer. Because an oxide semiconductor material has low off-current, oxide semiconductor materials may be suitable for a switching transistor that maintains a short turn-on time and a long turn-off time. In another example, another transistor among the first to seventh transistors T1 to T7 and the driving transistor D-TFT may be a transistor using low-temperature polysilicon (LTPS) as an active layer. Because a polysilicon material has high mobility and thus exhibits low power consumption and excellent reliability, a polysilicon material may be suitable for a driving transistor D-TFT.

The first to seventh transistors T1 to T7 and the driving transistor D-TFT may be an N-type transistor or a P-type transistor. In an N-type transistor, because a carrier is an electron, an electron may flow from a source electrode to a drain electrode, and current may flow from the drain electrode to the source electrode. In a P-type transistor, because a carrier is a hole, a hole may flow from a source electrode to a drain electrode, and current may flow from the source electrode to the drain electrode. For example, one transistor among the first to seventh transistors T1 to T7 and the driving transistor D-TFT may be an N-type transistor, and other transistors among the first to seventh transistors T1 to T7 and the driving transistor D-TFT may be a P-type transistor. The first to seventh transistors T1 to T7 and the driving transistor D-TFT may include one of a low-temperature polysilicon semiconductor layer and an oxide semiconductor layer or a combination thereof.

The pixel driving circuit may include the driving transistor D-TFT, the first to seventh transistors T1 to T7, and the storage capacitor Cstg.

The driving transistor D-TFT may include a first node N1, a second node N2, and a third node N3. In the driving transistor D-TFT, the second node N2 may be a gate node, the first node N1 may be a source node or a drain node, and the third node N3 may be a drain node or a source node. Hereinafter, for convenience of description, the driving transistor D-TFT, in which the second node N2 is a gate node, the first node N1 is a source node, and the third node N3 is a drain node, will be described by way of example. However, the aspects of the present disclosure are not limited thereto.

A gate electrode of the driving transistor D-TFT may be connected to the second node N2, and a first electrode of the driving transistor D-TFT may be connected to the first node N1. A second electrode of the driving transistor D-TFT may be connected to the third node N3. The driving transistor D-TFT may be controlled according to the voltage of the second node N2 to control the current flowing through the organic light-emitting diode OLED.

The first transistor T1 may be connected between the second node N2 and the third node N3. The first transistor T1 may be controlled in response to a first scan signal Scan1(n) to switch between the second node N2 and the third node N3.

The second transistor T2 may be connected to the first node N1. The second transistor T2 may be controlled in response to a second scan signal Scan2(n) to supply the data voltage Vdata to the first node N1.

The third transistor T3 may be connected to the first node N1. The third transistor T3 may be controlled in response to an emission control signal EM(n) to supply the high-potential driving voltage ELVDD, supplied through a high-potential driving voltage line, to the first node N1.

The fourth transistor T4 may be connected between the third node N3 and the fourth node N4. The fourth transistor T4 may be controlled in response to the emission control signal EM(n) to switch between the third node N3 and the fourth node N4.

The fifth transistor T5 may be connected to the second node N2. The fifth transistor T5 may be controlled in response to a fourth scan signal Scan4(n) to supply the initialization voltage Vini to the second node N2.

The sixth transistor T6 may be connected to the fourth node N4. The sixth transistor T6 may be controlled in response to a third scan signal Scan3(n) to supply the anode reset voltage VAR to the fourth node N4.

The seventh transistor T7 may be connected to the first node N1. The seventh transistor T7 may be controlled in response to the third scan signal Scan3(n) to supply the bias voltage Vobs to the first node N1. The hysteresis of the driving transistor D-TFT may be improved by adjusting a gate-source voltage Vgs flowing through the driving transistor D-TFT through the bias voltage Vobs. For example, the threshold voltage Vth of the driving transistor D-TFT may be changed based on the bias voltage Vobs.

The storage capacitor Cstg may be connected between a high-potential driving voltage terminal that supplies the high-potential driving voltage ELVDD and the second node N2. The storage capacitor Cstg may store the data voltage Vdata. For example, the storage capacitor Cstg may store the data voltage Vdata during one frame.

The organic light-emitting diode OLED may include an anode and a cathode. The anode of the organic light-emitting diode OLED may be connected to the fourth node N4. The cathode of the organic light-emitting diode OLED may be connected to a low-potential driving voltage line that supplies the low-potential driving voltage ELVSS.

The organic light-emitting diode OLED may include one of an organic emission layer, an inorganic emission layer, and a quantum dot emission layer, or may include a stacked or combined structure of an organic emission layer (or inorganic emission layer) and a quantum dot emission layer. For example, the organic light-emitting diode may include an anode, an organic layer, and a cathode. In another example, in addition to the organic light-emitting diode, a micro light-emitting diode (micro-LED) and a quantum dot light-emitting diode (QLED) including a quantum dot (QD) may be further used.

The organic light-emitting diode OLED may output light corresponding to one of various colors such as red, green, and blue, or may output white light.

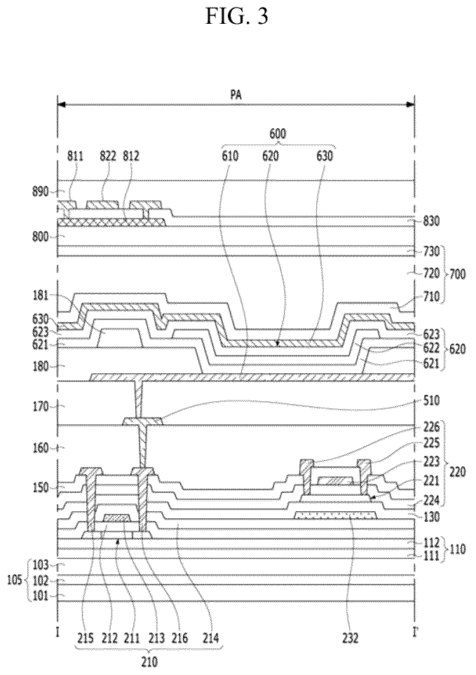

FIG. 3 is a cross-sectional view showing the display device according to the aspect of the present disclosure.

The display device according to the aspect of the present disclosure may include a device substrate 105. The device substrate 105 may include an insulative material. For example, the device substrate 105 may include glass or plastic. The device substrate 105 may have a multilayered structure. For example, the device substrate 105 may have a structure in which a first substrate layer 101, a substrate insulating layer 102, and a second substrate layer 103 are stacked in that order. The second substrate layer 103 may include the same material as the first substrate layer 101. For example, the first substrate layer 101 and the second substrate layer 103 may include a polymer material such as polyimide (PI). The substrate insulating layer 102 may include an insulative material. Accordingly, in the display device according to the aspect of the present disclosure, the device substrate 105 may have flexibility. Therefore, in the display device according to the aspect of the present disclosure, it may be possible to prevent damage to the device substrate 105 due to bending stress.

The device substrate 105 may include an active area, a bending area, and a pad area. An image to be provided to a user may be implemented in the active area AA. For example, the active area may include a plurality of pixel areas PA. Each pixel area PA may implement a specific color. For example, a light-emitting diode 600 may be disposed in each pixel area PA. The light-emitting diode 600 may emit light of a specific color. For example, the light-emitting diode 600 may include a first electrode 610, an emission layer 620, and a second electrode 630, which are stacked on the device substrate 105.

The first electrode 610 may include a conductive material. The first electrode 610 may be made of a material having high reflectivity. For example, the first electrode 610 may include metal such as aluminum (Al) or silver (Ag). However, the aspects of the present disclosure are not limited thereto. The first electrode 610 may have a multilayered structure. For example, the first electrode 610 may have a structure in which a reflective electrode made of metal is interposed between transparent electrodes made of a transparent conductive material such as ITO or IZO. However, the aspects of the present disclosure are not limited thereto.

The emission layer 620 may generate light having a brightness corresponding to a voltage difference between the first electrode 610 and the second electrode 630. For example, the emission layer 620 may include an emission material layer (EML) 622 including an emission material. The emission material may include an organic material, an inorganic material, or a hybrid material. For example, the display device according to the aspect of the present disclosure may be an organic light-emitting display device in which the emission layer 620 includes an emission material layer 622 made of an organic material. However, the aspects of the present disclosure are not limited thereto. The emission layer 620 may include an inorganic emission material. For example, the emission layer 620 may be made of a material including a quantum dot, a micro-LED, or a mini-LED. However, the aspects of the present disclosure are not limited thereto.

The emission layer 620 may have a multilayered structure. For example, the emission layer 620 may include at least one of a first common layer 621 located between the first electrode 610 and the emission material layer 622 or a second common layer 623 located between the emission material layer 622 and the second electrode 630. Each of the first common layer 621 and the second common layer 623 may include at least one of a hole injection layer (HIL), a hole transport layer (HTL), a hole blocking layer (HBL), an electron blocking layer (EBL), an electron transport layer (ETL), or an electron injection layer (EIL). However, the aspects of the present disclosure are not limited thereto. For example, in the display device according to the aspect of the present disclosure, the first common layer 621 may include at least one of an HIL, an EBL, or an HTL, and the second common layer 623 may include at least one of an ETL, an HBL, or an EIL.

The second electrode 630 may include a conductive material. The second electrode 630 may include a different material from the first electrode 610. However, the aspects of the present disclosure are not limited thereto. For example, the second electrode 630 may be a transparent electrode made of a transparent conductive material such as ITO or IZO. The second electrode 630 may have higher transmittance than the first electrode 610. Accordingly, in the display device according to the aspect of the present disclosure, light generated by the emission layer 620 may be emitted through the second electrode 630.

A driving circuit may be disposed in each pixel area PA. The driving circuit may generate a driving current that is provided to the light-emitting diode 600. The driving circuit may be electrically connected to signal lines GL, DL, ELVDD, and ELVSS. For example, each pixel area PA may be composed of signal lines GL, DL, ELVDD, and ELVSS. The signal lines GL, DL, ELVDD, and ELVSS may transmit various signals the cause each pixel PA to output light forming various images. For example, the signal lines GL, DL, ELVDD, and ELVSS may include a gate line GL applying a gate signal, a data line DL applying a data signal, and power voltage supply lines ELVDD and ELVSS supplying power voltages. However, the aspects of the present disclosure are not limited thereto. The driving circuit may generate a driving current corresponding to the data signal in response to the gate signal. The operation of the light-emitting diode 600 may be maintained during one frame. For example, the driving circuit may include a first thin-film transistor 210 and a second thin-film transistor 220. However, the aspects of the present disclosure are not limited thereto.

The first thin-film transistor 210 may be electrically connected to the light-emitting diode 600. The first thin-film transistor 210 may supply a driving current corresponding to the data signal to the light-emitting diode 600. For example, the first thin-film transistor 210 may be disposed between the light-emitting diode 600 and one of the power voltage supply lines ELVDD and ELVSS. The first thin-film transistor 210 may include a first semiconductor layer 211, a first insulating film 212, a first gate electrode 213, a second insulating film 214, a first source electrode 215, and a first drain electrode 216.

The first semiconductor layer 211 may be located close to the device substrate 105 and may include a semiconductor material. For example, the first semiconductor layer 211 may include silicon. The first semiconductor layer 211 may include a polycrystalline semiconductor. For example, the first semiconductor layer 211 may include polysilicon or LTPS. However, the aspects of the present disclosure are not limited thereto. In another example, the first semiconductor layer 211 may include an oxide semiconductor. The first semiconductor layer 211 may include a first source region, a first drain region, and a first channel region. The first channel region may be disposed between the first source region and the first drain region. The first channel region may have lower electrical conductivity than the first source region and the first drain region. For example, the first source region and the first drain region may include a conductive impurity having a higher concentration than that of the first channel region.

The first insulating film 212 may be disposed on the first semiconductor layer 211. The first insulating film 212 may extend to the outside of the first semiconductor layer 211. For example, the side surface of the first semiconductor layer 211 may be covered by the first insulating film 212. The first insulating film 212 may include an insulative material. For example, the first insulating film 212 may include silicon oxide (SiO) and/or silicon nitride (SiN). However, the aspects of the present disclosure are not limited thereto. The silicon oxide (SiO) may include silicon dioxide (SiO₂). The first insulating film 212 may include a material having a high dielectric constant. For example, the first insulating film 212 may include a material such as hafnium oxide (HfO). However, the aspects of the present disclosure are not limited thereto. The first insulating film 212 may be a gate insulating film, without being limited thereto.

The first gate electrode 213 may be disposed on the first insulating film 212. The first gate electrode 213 may include a conductive material. For example, the first gate electrode 213 may include a single layer or multiple layers including aluminum (Al), chromium (Cr), copper (Cu), titanium (Ti), molybdenum (Mo), tungsten (W), or alloys thereof. However, the aspects of the present disclosure are not limited thereto. The first gate electrode 213 may be insulated from the first semiconductor layer 211 by the first insulating film 212. The first gate electrode 213 may overlap the first channel region of the first semiconductor layer 211. For example, the first channel region of the first semiconductor layer 211 may have electrical conductivity corresponding to the voltage applied to the first gate electrode 213.

The second insulating film 214 may be disposed on the first gate electrode 213. The second insulating film 214 may extend to the outside of the first gate electrode 213. For example, the side surface of the first gate electrode 213 may be covered by the second insulating film 214. The second insulating film 214 may extend along the first insulating film 212. The second insulating film 214 may include an insulative material. For example, the second insulating film 214 may include silicon oxide (SiO). However, the aspects of the present disclosure are not limited thereto. The second insulating film 214 may be an interlayer insulating film, without being limited thereto.

The first source electrode 215 may be disposed on the second insulating film 214. The first source electrode 215 may be insulated from the first gate electrode 213 by the second insulating film 214. The first source electrode 215 may include a different material from the first gate electrode 213. However, the aspects of the present disclosure are not limited thereto. The first source electrode 215 may include a conductive material. For example, the first source electrode 215 may include a single layer or multiple layers including aluminum (Al), chromium (Cr), copper (Cu), titanium (Ti), molybdenum (Mo), tungsten (W), or alloys thereof. However, the aspects of the present disclosure are not limited thereto. The first source electrode 215 may be electrically connected to the first source region of the first semiconductor layer 211.

The first drain electrode 216 may be disposed on the second insulating film 214. The first drain electrode 216 may include a conductive material. For example, the first drain electrode 216 may include a single layer or multiple layers including aluminum (Al), chromium (Cr), copper (Cu), titanium (Ti), molybdenum (Mo), tungsten (W), or alloys thereof. However, the aspects of the present disclosure are not limited thereto. The first drain electrode 216 may be insulated from the first gate electrode 213 by the second insulating film 214. The first drain electrode 216 may include a different material from the first gate electrode 213. However, the aspects of the present disclosure are not limited thereto. For example, the first drain electrode 216 may include the same material as the first source electrode 215. The first drain electrode 216 may be formed through the same process as the first source electrode 215. The first drain electrode 216 may be electrically connected to the first drain region of the first semiconductor layer 211. The first drain electrode 216 may be separated from the first source electrode 215.

The concrete positions of the first source electrode 215 and the first drain electrode 216 will be described later.

The second thin-film transistor 220 may be electrically connected to the first thin-film transistor 210. The second thin-film transistor 220 may transmit the data signal to the first gate electrode 213 of the first thin-film transistor 210 in response to the scan signal. For example, the second thin-film transistor 220 may be disposed between the data line DL and the first gate electrode 213 of the first thin-film transistor 210. The structure of the second thin-film transistor 220 may be identical to that of the first thin-film transistor 210. However, the aspects of the present disclosure are not limited thereto. For example, the second thin-film transistor 220 may include a second semiconductor layer 221, a fourth insulating film 224, a second gate electrode 223, a second source electrode 225, and a second drain electrode 226.

The second semiconductor layer 221 may include a semiconductor material. The second semiconductor layer 221 may include the same material as or a different material from the first semiconductor layer 211. For example, the second semiconductor layer 221 may be an oxide semiconductor such as Indium Gallium Zinc Oxide (IGZO). In another example, the second semiconductor layer 221 may include polysilicon or LTPS)

The second semiconductor layer 221 may be disposed on a different layer from the first semiconductor layer 211. For example, a first protective film 130 may be located on the second insulating film 214, and the second semiconductor layer 221 may be disposed on the first protective film 130. The first protective film 130 may include silicon oxide (SiOx) or silicon nitride (SiNx). However, the aspects of the present disclosure are not limited thereto. Accordingly, in the display device according to the aspect of the present disclosure, it may be possible to prevent damage to the second semiconductor layer 221 due to the process of forming the first semiconductor layer 211.

The second semiconductor layer 221 may include a second source region, a second drain region, and a second channel region. The second channel region may be disposed between the second source region and the second drain region. The second source region and the second drain region may have lower resistance than the second channel region. For example, the second source region and the second drain region may include conductorized regions of the oxide semiconductor. The second channel region may be a non-conductorized region of the oxide semiconductor.

The fourth insulating film 224 may be disposed on the second semiconductor layer 221. The fourth insulating film 224 may include an insulative material. The fourth insulating film 224 may include the same material as the first insulating film 212. However, the aspects of the present disclosure are not limited thereto. For example, the fourth insulating film 224 may have a multilayered structure. However, the aspects of the present disclosure are not limited thereto.

The second gate electrode 223 may be disposed on the fourth insulating film 224. For example, the second gate electrode 223 may overlap the second channel region of the second semiconductor layer 221. The second gate electrode 223 may include a conductive material. For example, the second gate electrode 223 may include a single layer or multiple layers including aluminum (Al), chromium (Cr), copper (Cu), titanium (Ti), molybdenum (Mo), tungsten (W), or alloys thereof. However, the aspects of the present disclosure are not limited thereto. The second gate electrode 223 may include the same material as the first gate electrode 213. However, the aspects of the present disclosure are not limited thereto. The second gate electrode 223 may be insulated from the second semiconductor layer 221 by the fourth insulating film 224. For example, the second channel region of the second semiconductor layer 221 may have electrical conductivity corresponding to the voltage applied to the second gate electrode 223.

A second protective film 150 may be disposed on the fourth insulating film 224. The second protective film 150 may include silicon oxide (SiOx) or silicon nitride (SiNx). However, the aspects of the present disclosure are not limited thereto.

The second source electrode 225 may be disposed on the second protective film 150. The second source electrode 225 may include a conductive material. For example, the second source electrode 225 may include aluminum (Al), chromium (Cr), copper (Cu), titanium (Ti), molybdenum (Mo), tungsten (W), or alloys thereof. However, the aspects of the present disclosure are not limited thereto. The second source electrode 225 may include the same material as the first source electrode 215. However, the aspects of the present disclosure are not limited thereto. The second source electrode 225 may be insulated from the second gate electrode 223 by the fourth insulating film 224. The second source electrode 225 may include a different material from the second gate electrode 223. The second source electrode 225 may be electrically connected to the second source region of the second semiconductor layer 221. For example, the fourth insulating film 224 and the second protective film 150 may include second source contact holes to partially expose the second source region of the second semiconductor layer 221. The second source electrode 225 may include a region overlapping the second source region of the second semiconductor layer 221. For example, the second source electrode 225 may be in contact with the second source region of the second semiconductor layer 221 within the second source contact holes.

The second drain electrode 226 may be disposed on the second protective film 150. The second drain electrode 226 may include a conductive material. For example, the second drain electrode 226 may include a single layer or double layers including aluminum (Al), chromium (Cr), copper (Cu), titanium (Ti), molybdenum (Mo), tungsten (W), or alloys thereof. However, the aspects of the present disclosure are not limited thereto. The second drain electrode 226 may include the same material as the first drain electrode 216. However, the aspects of the present disclosure are not limited thereto. The second drain electrode 226 may be insulated from the second gate electrode 223 by the fourth insulating film 224. The second drain electrode 226 may include a different material from the second gate electrode 223. However, the aspects of the present disclosure are not limited thereto. For example, the second drain electrode 226 may include the same material as the second source electrode 225. However, the aspects of the present disclosure are not limited thereto. The second drain electrode 226 may be formed through the same process as the second source electrode 225. The second drain electrode 226 may be electrically connected to the second drain region of the second semiconductor layer 221. The second drain electrode 226 may be separated from the second source electrode 225. For example, the fourth insulating film 224 and the second protective film 150 may include second drain contact holes to partially expose the second drain region of the second semiconductor layer 221. The second drain electrode 226 may include a region overlapping the second drain region of the second semiconductor layer 221. For example, the second drain electrode 226 may be in contact with the second drain region of the second semiconductor layer 221 within the second drain contact holes.

The second thin-film transistor 220 may further include an auxiliary layer 232 located below the second semiconductor layer 221. The auxiliary layer 232 may overlap the second semiconductor layer 221. For example, the auxiliary layer 232 may include a single layer or multiple layers including aluminum (Al), chromium (Cr), copper (Cu), titanium (Ti), molybdenum (Mo), nickel (Ni), neodymium (Nd), tungsten (W), or alloys thereof. However, the aspects of the present disclosure are not limited thereto. The auxiliary layer 232 may prevent light from reaching the second semiconductor layer 221, thereby increasing the lifespan of the second thin-film transistor 220. For example, the auxiliary layer 232 may be a light blocking layer, without being limited thereto. For example, the auxiliary layer may be formed below the first thin-film transistor 210. The auxiliary layer may be disposed on the buffer layer 112. When an auxiliary layer is formed, an insulating film may be further formed on the buffer layer 112. The auxiliary layer may be made of the same material as the auxiliary layer 232. However, the aspects of the present disclosure are not limited thereto. The auxiliary layer may prevent light from reaching the first semiconductor layer 211, thereby increasing the lifespan of the first thin-film transistor 210.

A buffer film 110 may be disposed between the device substrate 105 and the driving circuit in each pixel area PA. The buffer film 110 may prevent contamination caused by the device substrate 105 during the process of forming the driving circuits. For example, the buffer film 110 may cover the active area AA of the device substrate 105. For example, the buffer film 110 may completely cover the active area AA of the device substrate 105. The buffer film 110 may be disposed between the device substrate 105 and the first semiconductor layer 211 in each pixel area PA. The buffer film 110 may include an insulative material. For example, the buffer film 110 may include an inorganic insulative material such as silicon oxide (SiO) or silicon nitride (SiN). However, the aspects of the present disclosure are not limited thereto. The buffer film 110 may have a multilayered structure. For example, the buffer film 110 may have a structure in which a first buffer layer 111 and a second buffer layer 112 including a different material from the first buffer layer 111 are stacked. However, the aspects of the present disclosure are not limited thereto.

The first protective film 130 may prevent damage to the first thin-film transistor 210 due to external impact and moisture. The first protective film 130 may extend between the auxiliary layer 232 and the second semiconductor layer 221 in each pixel area PA. Accordingly, in the display device according to the aspect of the present disclosure, it may be possible to effectively prevent damage to the first thin-film transistor 210 due to external impact and moisture.

The second protective film 150 may be disposed between the fourth insulating film 224 and the second source electrode 225 and between the fourth insulating film 224 and the second drain electrode 226 in each pixel area PA. The second protective film 150 may prevent damage to the second semiconductor layer 221 due to external impact and moisture. For example, the second protective film 150 may extend to the outside of the second semiconductor layer 221 along the fourth insulating film 224. The second protective film 150 may include a different material from the fourth insulating film 224. For example, the fourth protective film 224 may include silicon nitride (SiN). However, the aspects of the present disclosure are not limited thereto. Accordingly, in the display device according to the aspect of the present disclosure, it may be possible to effectively prevent damage to the second semiconductor layer 221 due to external impact and moisture.

The first source electrode 215 of the first thin-film transistor may be disposed on the second protective film 150 in each pixel area PA. The first source electrode 215 may include a conductive material. For example, the first source electrode 215 may include a single layer or multiple layers including aluminum (Al), chromium (Cr), copper (Cu), titanium (Ti), molybdenum (Mo), tungsten (W), or alloys thereof. However, the aspects of the present disclosure are not limited thereto. The first source electrode 215 may include a different material from the first gate electrode 213. However, the aspects of the present disclosure are not limited thereto. The first source electrode 215 may be electrically connected to the first source region of the first semiconductor layer 211. For example, the first insulating film 212, the second insulating film 214, the first protective film 130, the fourth insulating film 224, and the second protective film 150 may include contact holes to partially expose the first source region of the first semiconductor layer 211 of the first thin-film transistor 210. The first source electrode 215 may include a region overlapping the first source region of the first semiconductor layer 211. For example, the first source electrode 215 may be in contact with the first source region of the first semiconductor layer 211 within the first source contact holes.

The first drain electrode 216 of the first thin-film transistor may be disposed on the second protective film 150 in each pixel area PA. The first drain electrode 216 may include a conductive material. For example, the first drain electrode 216 may include a single layer or multiple layers including aluminum (Al), chromium (Cr), copper (Cu), titanium (Ti), molybdenum (Mo), tungsten (W), or alloys thereof. However, the aspects of the present disclosure are not limited thereto. The first drain electrode 216 may include a different material from the first gate electrode 213. However, the aspects of the present disclosure are not limited thereto. For example, the first drain electrode 216 may include the same material as the first source electrode 215. However, the aspects of the present disclosure are not limited thereto. The first drain electrode 216 may be formed through the same process as the first source electrode 215. The first drain electrode 216 may be electrically connected to the first drain region of the first semiconductor layer 211. The first drain electrode 216 may be separated from the first source electrode 215. For example, the first insulating film 212, the second insulating film 214, the first protective film 130, the fourth insulating film 224, and the second protective film 150 may include contact holes to partially expose the first drain region of the first semiconductor layer 211. The first drain electrode 216 may include a region overlapping the first drain region of the first semiconductor layer 211. For example, the first drain electrode 216 may be in contact with the first drain region of the first semiconductor layer 211 within the first contact holes.

The light-emitting diode 600 in each pixel area PA may be disposed on the transistors in the corresponding pixel area PA. For example, the first thin-film transistor 210 and the second thin-film transistor 220 in each pixel area PA may be disposed between the device substrate 105 and the first electrode 610 in the corresponding pixel area PA. Accordingly, in the display device according to the aspect of the present disclosure, the area occupied by each pixel area PA may be minimized. Thus, the display device according to the aspect of the present disclosure may exhibit improved resolution.

A first protective layer 160 and a second protective layer 170 may be disposed between the driving circuit and the light-emitting diode 600 in each pixel area PA. For example, the first electrode 610, the emission layer 620, and the second electrode 630 in each pixel area PA may be disposed on the second protective layer 170 in the corresponding pixel area PA. The first protective layer 160 and the second protective layer 170 may reduce or eliminate steps (e.g., planarize) caused by the transistors. For example, the upper surface of the second protective layer 170 facing the light-emitting diode 600 in each pixel area PA may be a flat or planar surface. The first protective layer 160 and the second protective layer 170 may include an insulative material. For example, the first protective layer 160 and the second protective layer 170 may include an organic insulative material. The second protective layer 170 may include a different material from the first protective layer 160. Accordingly, in the display device according to the aspect of the present disclosure, it may be possible to effectively reduce or eliminate steps caused by the transistors.

An intermediate electrode 510 may be disposed between the first protective layer 160 and the second protective layer 170 in each pixel area PA. The light-emitting diode 600 may be electrically connected to the first drain electrode 216 of the first thin-film transistor 210 via the intermediate electrode 510. For example, the intermediate electrode 510 may penetrate the first protective layer 160 to be connected to the first drain electrode 216, and the first electrode 610 of the light-emitting diode 600 may penetrate the second protective layer 170 to be connected to the intermediate electrode 510. The intermediate electrode 510 may include a region overlapping the first drain electrode 216 and a region overlapping the first electrode 610. For example, the intermediate electrode 510 may be disposed between the first drain electrode 216 and the first electrode 610. The intermediate electrode 510 may be in contact with the first drain electrode 216. For example, the intermediate electrode 510 may be in direct contact with the first drain electrode 216. The first electrode 610 may be in contact with the intermediate electrode 510. For example, the first electrode 610 may be in direct contact with the intermediate electrode 510. The intermediate electrode 510 may include a conductive material. For example, the intermediate electrode 510 may include a metal such as aluminum (Al), chromium (Cr), copper (Cu), titanium (Ti), molybdenum (Mo), or tungsten (W). The intermediate electrode 510 may include a different material from the first drain electrode 216 and the first electrode 610. However, the aspects of the present disclosure are not limited thereto.

A bank 180 may be disposed on the second protective layer 170 in each pixel area PA. The bank 180 may include an insulative material. For example, the bank 180 may be made of a material including black pigment or an organic material such as benzocyclobutene resin, polyimide resin, acrylic resin, or photosensitive polymer. However, the aspects of the present disclosure are not limited thereto. If the bank 180 is made of a material including black pigment or black dye, the bank 180 may be a black bank. If the bank 180 is made of a material including black pigment or black dye, light from the outside may be blocked, and the brightness of the display device may be further improved. The bank 180 may include a different material from the first protective layer 160 and the second protective layer 170. The bank 180 may cover the edge of the first electrode 610. The emission layer 620 and the second electrode 630 in each pixel area PA may be disposed on a portion of the first electrode 610 exposed by the bank 180. For example, the bank 180 may define an emission area within each pixel area PA.

A spacer 181 may be disposed on the bank 180 in each pixel area PA. The spacer 181 may be formed to have a smaller width than the bank 180. The spacer 181 may include an insulative material. For example, the spacer 181 may include an organic insulative material. The spacer 181 may be formed of the same material as the bank 180. However, the aspects of the present disclosure are not limited thereto. The spacer 181 may prevent damage to the bank 180 and the emission material layer 622 formed in an adjacent pixel area PA due to a fine metal mask.

The emission layer 620 in each pixel area PA may extend onto the bank 180 and the spacer 181. Each pixel area PA may display a different color from that of a pixel area PA adjacent thereto. For example, the emission material layer 622 in each pixel area PA may be separated from the emission material layer 622 in a pixel area PA adjacent thereto. The emission material layer 622 in each pixel area PA may include an end portion located within the corresponding pixel area PA. The emission material layer 622 may be formed using a fine metal mask (FMM). An end portion of each emission material layer 622 may be disposed on the bank 180 and the spacer 181. The first common layer 621 and the second common layer 622 of each emission layer 620 may extend along the surface of the bank 180. For example, the first common layer 621 and the second common layer 623 in each pixel area PA may be connected to the first common layer 621 and the second common layer 623 in a pixel area PA adjacent thereto. Accordingly, in the display device according to the aspect of the present disclosure, process efficiency may be improved.

The voltage supplied to the second electrode 630 in each pixel area PA may be identical to the voltage supplied to the second electrode 630 in a pixel area PA adjacent thereto. For example, the second electrode 630 in each pixel area PA may be connected to the second electrode 630 in a pixel area PA adjacent to the bank 180. Accordingly, the display device according to the aspect of the present disclosure may control the brightness of each pixel area PA based on the gate signal and the data signal applied to the corresponding pixel area PA. The second electrode 630 in each pixel area PA may be in contact with the second electrode 630 in a pixel area PA adjacent thereto.

An encapsulation member 700 may be disposed on the light-emitting diode 600 in each pixel area PA. The encapsulation member 700 may prevent damage to the light-emitting diodes 600 due to external impact and moisture. The encapsulation member 700 may have a multilayered structure. However, the aspects of the present disclosure are not limited thereto. For example, the encapsulation member 700 may include a first encapsulation layer 710, a second encapsulation layer 720, and a third encapsulation layer 730. However, the aspects of the present disclosure are not limited thereto. The first encapsulation layer 710, the second encapsulation layer 720, and the third encapsulation layer 730 may include an insulative material. The second encapsulation layer 720 may include a different material from the first encapsulation layer 710 and the third encapsulation layer 730. However, the aspects of the present disclosure are not limited thereto. For example, the first encapsulation layer 710 and the third encapsulation layer 730 may include an inorganic insulative material, and the second encapsulation layer 720 may include an organic insulative material. Accordingly, in the display device according to the aspect of the present disclosure, it may be possible to effectively prevent damage to the light-emitting diodes 600 due to external impact and moisture. Steps caused by the light-emitting diode 600 in each pixel area PA may be removed by the encapsulation member 700. For example, the upper surface of the encapsulation member 700 facing the device substrate 105 may be a flat surface.

The touch unit may be disposed on the encapsulation member 700. The touch unit may detect touch of a user and/or a tool. For example, the touch unit may include touch electrodes 811 and 822 and bridge electrodes 812. The touch electrodes 811 and 822 may be disposed parallel to each other. The bridge electrodes 812 may interconnect the touch electrodes 811 and 822. The touch electrodes 811 and 822 and the bridge electrodes 812 may include a conductive material. For example, the touch electrodes 811 and 822 and the bridge electrodes 812 may include a single layer or double layers including aluminum (Al), chromium (Cr), copper (Cu), titanium (Ti), molybdenum (Mo), tungsten (W), or alloys thereof. However, the aspects of the present disclosure are not limited thereto. The touch electrodes 811 and 822 and the bridge electrodes 812 may overlap the active area of the device substrate 105. The light-emitting diode 600 in each pixel area PA may be disposed outside the touch electrodes 811 and 822 and the bridge electrodes 812. For example, the touch electrodes 811 and 822 and the bridge electrodes 812 may overlap the bank 180. The touch electrodes 811 and 822 and the bridge electrodes 812 may be separated from the light-emitting diode 600 in each pixel area PA. Accordingly, in the display device according to the aspect of the present disclosure, light emitted from each light-emitting diode 600 in a direction perpendicular to the upper surface of the device substrate 105 may not be blocked by the touch electrodes 811 and 822 and the bridge electrodes 812. Therefore, in the display device according to the aspect of the present disclosure, it may be possible to prevent the reduction in brightness of each pixel area PA due to the touch electrodes 811 and 822 and the bridge electrodes 812.

A touch insulating film 830 may be disposed between the bridge electrodes 812 and the touch electrodes 811 and 822. The touch insulating film 830 may include an insulative material. For example, the touch insulating film 830 may include a material such as silicon oxide (SiOx) or silicon nitride (SiNx). However, the aspects of the present disclosure are not limited thereto. The second touch electrodes 822 may be disposed on the same layer as the first touch electrodes 811. For example, the touch electrodes 811 and 822 and bridge electrodes interconnecting the touch electrodes 822 may be disposed on the touch insulating film 830 covering the bridge electrodes 812. The touch insulating film 830 may include touch contact holes to partially expose the bridge electrode 812. The touch electrode 811 may be connected to the corresponding bridge electrode 812 through one of the touch contact holes.

A touch buffer film 800 may be disposed between the encapsulation member 700 and the touch electrodes 811, bridge electrodes 812, and touch electrodes 822 of the touch unit. The touch buffer film 800 may prevent damage to the encapsulation member 700 and the light-emitting diodes 600 due to the process of forming the touch electrodes 811 and 822 and the bridge electrodes 812. The touch buffer film 800 may include an insulative material. For example, the touch buffer film 800 may include a material such as silicon oxide (SiOx) or silicon nitride (SiNx). However, the aspects of the present disclosure are not limited thereto.

An insulating film 890 may be disposed on the touch electrodes 811, bridge electrodes 812, and touch electrodes 822 of the touch unit. The insulating film 890 may prevent damage to the touch electrodes 811, bridge electrodes 812, and touch electrodes 822 of the touch unit due to external impact and moisture.

The display device according to the present disclosure described with reference to FIGS. 1 and 2 may employ variable refresh rate (VRR) technology to reduce power consumption. The display device may be driven using the VRR technology that varies a frequency.

For example, the display device may be driven at 120 Hz and may then be driven at 60 Hz. If the display device is driven while varying the frequency, it is necessary to reduce visibility when varying the frequency. Therefore, when the display device is driven at 120 Hz and then is driven at 60 Hz, intermediate frequencies (80 Hz, 48 Hz, etc.) may be used to reduce visibility.

In some cases, the display device needs to be driven using an anode reset frame to use intermediate frequences. For example, the anode reset frame may be set to 4 ms (Scan3 240 Hz). However, the aspects of the present disclosure are not limited thereto.

As described with reference to FIG. 1, the gate driving circuit 300 may include at least one scan driver 310 and an emission driver 320. In one example, the at least one scan driver 310 may generate a scan signal SC and supply the same to the gate lines GL in a row-sequential manner to drive at least one scan line SCL connected to each pixel row. The emission driver 320 may generate an emission signal EM and supply the same to the emission lines in a row-sequential manner to drive at least one emission line EML connected to each pixel row. The gate driving circuit 300 may be disposed on one side or both sides of the display panel 100 in a gate-in-panel (GIP) manner.

Each of the at least one scan driver 310 and the emission driver 320 may include a plurality of stages that are cascade-connected to each other.

Each stage may include a set node, a reset node, a node controller configured to control voltages of the set node and the reset node, and an output buffer configured to output a scan signal or an emission control signal to a corresponding gate line according to the voltages of the set node and the reset node. Each stage may output one or two or more scan signals and emission control signals during one frame.

In addition, to implement a narrow bezel, each stage (of the scan driver 310 or the emission driver 320) may be driven in response to one clock signal.

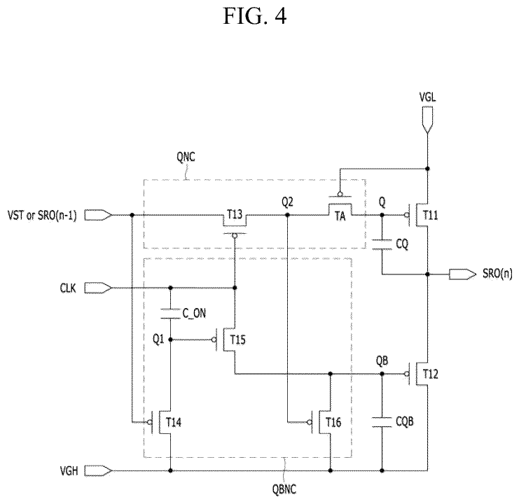

FIG. 4 is a diagram showing the configuration of a gate driving circuit according to an aspect of the present disclosure. FIG. 4 shows one stage of the emission driver of the gate driving circuit in accordance with some aspects of the disclosure.

Referring to FIG. 4, the emission driver of the gate driving circuit according to the aspect of the present disclosure may include a first output transistor T11, a second output transistor T12, a transfer transistor TA, a first transistor T13, a second transistor T14, a third transistor T15, a fourth transistor T16, a first capacitor CQ, a second capacitor CQB, and a third capacitor C_ON.

The first output transistor T11 may be connected to a set node Q. The first output transistor T11 may pull-up drive an output terminal SRO(n) in response to a signal (voltage) applied to the set node Q. The second output transistor T12 may be connected to a reset node QB. The second output transistor T12 may pull-down drive the output terminal SRO(n) in response to a signal (voltage) of the reset node QB.

For example, the first output transistor T11 may be connected between a gate low voltage line that supplies a gate low voltage VGL and the output terminal SRO(n). The first output transistor T11 may output the gate low voltage VGL to the output terminal SRO(n) in response to a signal (voltage) of the set node Q.

The second output transistor T12 may be connected between the output terminal SRO(n) and a gate high voltage line that supplies a gate high voltage VGH. The second output transistor T12 may output the gate high voltage VGH to the output terminal SRO(n) in response to a signal (voltage) of the reset node QB.

The transfer transistor TA may be connected between a node Q2 and the set node Q. The transfer transistor TA may transfer the voltage of the node Q2 to the set node Q in response to the gate low voltage VGL.

The first transistor T13 may be connected to the node Q2. The first transistor T13 may be connected between the node Q2 and a supply line that supplies a start signal VST or an output signal SRO(n−1) of a previous stage. The first transistor T13 may provide the start signal VST or the output signal SRO(−1) of the previous stage to the node Q2 in response to the clock signal CLK.

The second transistor T14 may be connected to a node Q1. The second transistor T14 may be connected between the gate high voltage line that supplies the gate high voltage VGH and the node Q1. The second transistor T14 may provide the gate high voltage VGH to the node Q1 in response to the voltage of the start signal VST or the output signal SRO(n−1) of the previous stage.

The third transistor T15 may be connected between the reset node QB and a clock signal line that supplies the clock signal CLK. The third transistor T15 may provide the clock signal CLK to the reset node QB in response to the voltage of the node Q1.

The fourth transistor T16 may be connected between the gate high voltage line that supplies the gate high voltage VGH and the reset node QB. The fourth transistor T16 may provide the gate high voltage VGH to the reset node QB in response to the voltage of the node Q2 or the set node Q.

The first capacitor CQ may be located or coupled between the set node Q and the output terminal SRO(n). The second capacitor CQB may be located or coupled between the reset node and the gate high voltage line that supplies the gate high voltage VGH. The third capacitor C_ON may be located or coupled between the node Q1 and the clock signal line that supplies the clock signal CLK.

For example, the first capacitor CQ may be connected between the set node Q and the output terminal SRO(n). The second capacitor CQB may be connected between the reset node QB and the gate high voltage line that supplies the gate high voltage VGH. The third capacitor C_ON may be connected between the node Q1 and the clock signal line that supplies the clock signal CLK.

The first output transistor T11, the second output transistor T12, the transfer transistor TA, the first transistor T13, the second transistor T14, the third transistor T15, and the fourth transistor T16 may be implemented as different types of transistors.

For example, one transistor among the first output transistor T11, the second output transistor T12, the transfer transistor TA, the first transistor T13, the second transistor T14, the third transistor T15, and the fourth transistor T16 may be an oxide transistor using an oxide semiconductor as an active layer. Because an oxide semiconductor material has low off-current, the oxide semiconductor material may be suitable for a switching transistor that maintains a short turn-on time and a long turn-off time. The active layer may be a semiconductor layer, without being limited thereto. For example, one of the first output transistor T11, the second output transistor T12, the transfer transistor TA, the first transistor T13, the second transistor T14, the third transistor T15, and the fourth transistor T16 may include one of an oxide semiconductor layer and a low-temperature polysilicon semiconductor layer or a combination thereof.

In another example, another transistor among the first output transistor T11, the second output transistor T12, the transfer transistor TA, the first transistor T13, the second transistor T14, the third transistor T15, and the fourth transistor T16 may be a transistor using low-temperature polysilicon (LTPS) as an active layer. Because a polysilicon material has high mobility and thus exhibits low power consumption and excellent reliability, the polysilicon material may be suitable for a driving transistor D-TFT.

The first output transistor T11, the second output transistor T12, the transfer transistor TA, the first transistor T13, the second transistor T14, the third transistor T15, and the fourth transistor T16 may be N-type transistors or P-type transistors.

In an N-type transistor, because a carrier is an electron, an electron may flow from a source electrode to a drain electrode, and current may flow from the drain electrode to the source electrode. In a P-type transistor, because a carrier is a hole, a hole may flow from a source electrode to a drain electrode, and current may flow from the source electrode to the drain electrode.

Although the first output transistor T11, the second output transistor T12, the transfer transistor TA, the first transistor T13, the second transistor T14, the third transistor T15, and the fourth transistor T16 are illustrated in FIG. 4 as being implemented as P-type transistors, the aspects of the present disclosure are not limited thereto.

In FIG. 4, the first transistor T13 and the transfer transistor TA may be referred to as a first controller QNC that controls the voltage of the set node Q, and the second to fourth transistors T14, T15, and T16 may be referred to as a second controller QBNC that controls the voltage of the reset node QB.

Hereinafter, the operation of the emission driver of the gate driving circuit of the display device according to the aspect of the present disclosure configured as described above will be described.

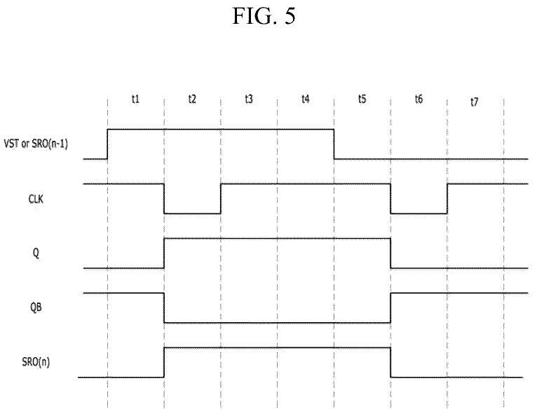

FIG. 5 is a waveform diagram of the emission driver in the gate driving circuit of the display device according to the aspect of the present disclosure.

As shown in FIG. 5, in a first period t1 in which the level of the start signal VST or the output signal SRO(n−1) of the previous stage is high and the level of the clock signal CLK is high, the first transistor T13 and the second transistor T14 may be turned off, and the third and fourth transistors T15 and T16 may be turned on because the node Q1 and the node Q2 are maintained at a low level in a previous step.

Accordingly, the set node Q may maintain a low voltage, which is a low level, and the gate high voltage VGH may be provided to the reset node QB.

Therefore, the first output transistor T11 may be turned on, and the second output transistor T12 may be turned off, whereby the gate low voltage VGL may be output to the output terminal SRO(n).

In a second period t2 in which the start signal GVST or the output signal SRO(n−1) of the previous stage is maintained at a high level and the clock signal CLK transitions to a low level, the first transistor T13 and the third transistor T15 may be turned on, whereby the node Q2 and the set node Q may be charged with the high-level voltage of the start signal GVST or the output signal SRO(n−1) of the previous stage, and the reset node QB may be discharged to the low-level voltage of the clock signal CLK. Therefore, the second transistor T14 and the fourth transistor T16 may be turned off.

Therefore, the first output transistor T11 may be turned off, and the second output transistor T12 may be turned on, whereby the gate high voltage VGH may be output to the output terminal SRO(n).

In third and fourth periods t3 and t4 in which the level of the start signal GVST or the output signal SRO(n−1) of the previous stage is high and the clock signal CLK transitions to a high level, the first to fourth transistors T13 to T16 may be turned off, whereby the node Q2 and the set node Q may maintain the high-level voltage of the start signal GVST or the output signal SRO(n−1) of the previous stage, and the reset node QB may maintain the low-level voltage of the clock signal CLK.

Therefore, the first output transistor T11 may be turned off, and the second output transistor T12 may be turned on, whereby the gate high voltage VGH may be output to the output terminal SRO(n).

In a fifth period t5 in which the start signal GVST or the output signal SRO(n−1) of the previous stage transitions to a low level and the clock signal CLK is maintained at a high level, the first transistor T13, the third transistor T15, and the fourth transistor T16 may remain in the turned-off state, and the second transistor T14 may be turned on.

Accordingly, the node Q2 and the set node Q may maintain the high-level voltage of the start signal GVST or the output signal SRO(n−1) of the previous stage, and the reset node QB may maintain the low-level voltage of the clock signal CLK.

Therefore, the first output transistor T11 may be turned off, and the second output transistor T12 may be turned on, whereby the gate high voltage VGH may be output to the output terminal SRO(n).

In a sixth period t6 in which the start signal GVST or the output signal SRO(n−1) of the previous stage is maintained at a low level and the clock signal CLK transitions to a low level, the first transistor T13, the second transistor T14, and the fourth transistor T16 may be turned on, and the third transistor T15 may be turned off.

Accordingly, the node Q2 and the set node Q may transition to the low-level voltage of the start signal GVST or the output signal SRO(n−1) of the previous stage, and the gate high voltage VGH may be applied to the reset node QB through the fourth transistor T16.

Therefore, the first output transistor T11 may be turned on, and the second output transistor T12 may be turned off, whereby the gate low voltage VGL may be output to the output terminal SRO(n).

In a seventh period t7 in which the start signal GVST or the output signal SRO(n−1) of the previous stage is maintained at a low level and the clock signal CLK transitions to a high level, the first transistor T13 and the third transistor T15 may be turned off, and the second transistor T14 and the fourth transistor T16 may remain in the turned-on state.

Accordingly, the node Q2 and the set node Q may maintain the low-level voltage of the start signal GVST or the output signal SRO(n−1) of the previous stage, and the reset node QB may maintain the gate high voltage VGH.

Therefore, the first output transistor T11 may be turned on, and the second output transistor T12 may be turned off, whereby the gate low voltage VGL may be output to the output terminal SRO(n).

Since the gate driving circuit according to the aspect of the present disclosure uses only one clock signal, a narrow bezel may be implemented.

In addition, the gate driving circuit according to the aspect of the present disclosure may achieve variable frequency driving. For example, the gate driving circuit according to the aspect of the present disclosure may employ variable refresh rate (VRR) technology to reduce power consumption. The gate driving circuit may be driven using the VRR technology that varies a frequency.

For example, the gate driving circuit may be driven at 120 Hz and may then be driven at 60 Hz. If the gate driving circuit is driven while varying the frequency, it is necessary to reduce visibility when varying the frequency. Therefore, when the gate driving circuit is driven at 120 Hz and then is driven at 60 Hz, intermediate frequencies (80 Hz, 48 Hz, etc.) may be used to reduce visibility.

In some cases, the gate driving circuit needs to be driven using an anode reset frame to use the intermediate frequencies. For example, the anode reset frame may be set to 4 ms (Scan3 240 Hz). However, the aspects of the present disclosure are not limited thereto.

Even in abnormal on/off situations, stable output may be secured by supplying the gate high voltage VGH to the set node Q. The configuration for accomplishing this will be described below.

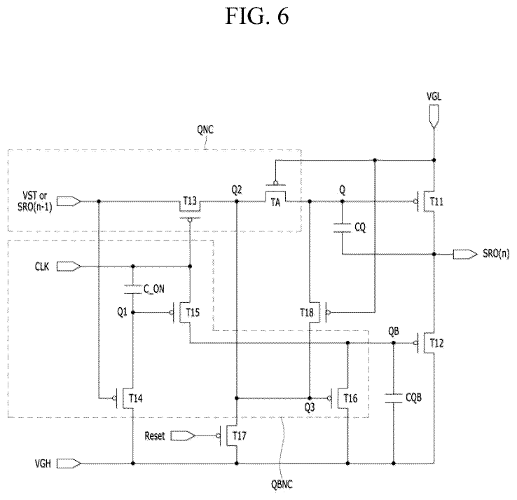

FIG. 6 is a diagram showing the configuration of a gate driving circuit according to another aspect of the present disclosure. FIG. 6 shows one stage of the emission driver of the gate driving circuit.

Referring to FIG. 6, the emission driver of the gate driving circuit according to the other aspect of the present disclosure may include a first output transistor T11, a second output transistor T12, a transfer transistor TA, a first transistor T13, a second transistor T14, a third transistor T15, a fourth transistor T16, a first reset transistor T17, a second reset transistor T18, a first capacitor CQ, a second capacitor CQB, and a third capacitor C_ON.

The first output transistor T11 may pull-up drive an output terminal SRO(n) in response to a signal (voltage) applied to the set node Q. The second output transistor T12 may pull-down drive the output terminal SRO(n) in response to a signal (voltage) of the reset node QB.

For example, the first output transistor T11 may be connected between a gate low voltage line that supplies a gate low voltage VGL and the output terminal SRO(n). The first output transistor T11 may output the gate low voltage VGL to the output terminal SRO(n) in response to a signal (voltage) of the set node Q.

The second output transistor T12 may be connected between the output terminal SRO(n) and a gate high voltage line that supplies a gate high voltage VGH. The second output transistor T12 may output the gate high voltage VGH to the output terminal SRO(n) in response to a signal (voltage) of the reset node QB.

The transfer transistor TA may be connected between a node Q2 and the set node Q. The transfer transistor TA may transfer the voltage of the node Q2 to the set node Q in response to the gate low voltage VGL.

The first transistor T13 may be connected between the node Q2 and a supply line that supplies a start signal VST or an output signal SRO(n−1) of a previous stage (e.g., cascade connected to a previous gate driving circuit). The first transistor T13 may provide the start signal VST or the output signal SRO(n−1) of the previous stage to the node Q2 in response to the clock signal CLK.

The second transistor T14 may be connected between the gate high voltage line that supplies the gate high voltage VGH and the node Q1. The second transistor T14 may provide the gate high voltage VGH to the node Q1 in response to the voltage of the start signal VST or the output signal SRO(n−1) of the previous stage.

The third transistor T15 may be connected between the reset node QB and a clock signal line that supplies the clock signal CLK. The third transistor T15 may provide the clock signal CLK to the reset node QB in response to the voltage of the node Q1.

The fourth transistor T16 may be connected between the gate high voltage line that supplies the gate high voltage VGH and the reset node QB. The fourth transistor T16 may provide the gate high voltage VGH to the reset node QB in response to the voltage of the node Q2 or the set node Q.

The first reset transistor T17 may be connected between the gate high voltage line that supplies the gate high voltage VGH and the node Q2. The first reset transistor T17 may provide the gate high voltage VGH to the node Q2 in response to a reset signal Reset that is opposite in phase with respect to the start signal VST.

The second reset transistor T18 may be connected between the set node Q and a gate node of the fourth transistor T16. The second reset transistor T18 may connect the set node Q to the gate node of the fourth transistor T16 in response to the gate low voltage VGL. For example, one of the first reset transistor T17 and the second reset transistor T18 may include an oxide semiconductor layer or a low-temperature polysilicon semiconductor layer. However, the aspects of the present disclosure are not limited thereto.

The first capacitor CQ may be located or coupled between the set node Q and the output terminal SRO(n). The second capacitor CQB may be located or coupled between the reset node QB and the gate high voltage line that supplies the gate high voltage VGH. The third capacitor C_ON may be located or coupled between the node Q1 and the clock signal line that supplies the clock signal CLK.

For example, the first capacitor CQ may be connected between the set node Q and the output terminal SRO(n). The second capacitor CQB may be connected between the reset node QB and the gate high voltage line that supplies the gate high voltage VGH. The third capacitor C_ON may be connected between the node Q1 and the clock signal line that supplies the clock signal CLK.

The first output transistor T11, the second output transistor T12, the transfer transistor TA, the first transistor T13, the second transistor T14, the third transistor T15, the fourth transistor T16, the first reset transistor T17, and the second reset transistor T18 may be implemented as different types of transistors.

For example, one transistor among the first output transistor T11, the second output transistor T12, the transfer transistor TA, the first transistor T13, the second transistor T14, the third transistor T15, the fourth transistor T16, the first reset transistor T17, and the second reset transistor T18 may be an oxide transistor using an oxide semiconductor as an active layer. Because an oxide semiconductor material has low off-current, an oxide semiconductor material may be suitable for a switching transistor that maintains a short turn-on time and a long turn-off time.

In another example, another transistor among the first output transistor T11, the second output transistor T12, the transfer transistor TA, the first transistor T13, the second transistor T14, the third transistor T15, the fourth transistor T16, the first reset transistor T17, and the second reset transistor T18 may be a transistor using LTPS as an active layer. Because a polysilicon material has high mobility and thus exhibits low power consumption and excellent reliability, the polysilicon material may be suitable for a driving transistor D-TFT. For example, one of the first output transistor T11, the second output transistor T12, the transfer transistor TA, the first transistor T13, the second transistor T14, the third transistor T15, the fourth transistor T16, the first reset transistor T17, and the second reset transistor T18 may include one of a low-temperature polysilicon semiconductor layer and an oxide semiconductor layer or a combination thereof.

The first output transistor T11, the second output transistor T12, the transfer transistor TA, the first transistor T13, the second transistor T14, the third transistor T15, the fourth transistor T16, the first reset transistor T17, and the second reset transistor T18 may be N-type transistors or P-type transistors.

In an N-type transistor, because a carrier is an electron, an electron may flow from a source electrode to a drain electrode, and current may flow from the drain electrode to the source electrode. In a P-type transistor, because a carrier is a hole, a hole may flow from a source electrode to a drain electrode, and current may flow from the source electrode to the drain electrode.

Although the first output transistor T11, the second output transistor T12, the transfer transistor TA, the first transistor T13, the second transistor T14, the third transistor T15, the fourth transistor T16, the first reset transistor T17, and the second reset transistor T18 are illustrated in FIG. 6 as being implemented as P-type transistors, the aspects of the present disclosure are not limited thereto.

In FIG. 6, the first transistor T13 and the transfer transistor TA may constitute a first controller QNC that controls the voltage of the set node Q, and the second to fourth transistors T14, T15, and T16 may constitute a second controller QBNC that controls the voltage of the reset node QB.

The gate driving circuit according to the other aspect of the present disclosure may further include the first reset transistor T17 in addition to the elements of the gate driving circuit according to the aspect of the present disclosure described with reference to FIG. 4. The first reset transistor T17 may enhance the voltage of the set node Q using the reset signal Reset, which is opposite in phase with respect to the start signal VST and is delayed by a predetermined period of time t1 with respect to the start signal VST.

In addition, the gate driving circuit according to the other aspect of the present disclosure may further include the second reset transistor T18 to improve a ripple from the gate node of the fourth transistor T16 to the set node Q.

Therefore, even in abnormal on/off situations, stable output may be secured by supplying the gate high voltage VGH, which is a DC voltage, to the set node Q.

Hereinafter, the operation of the emission driver of the gate driving circuit of the display device according to the other aspect of the present disclosure will be described.

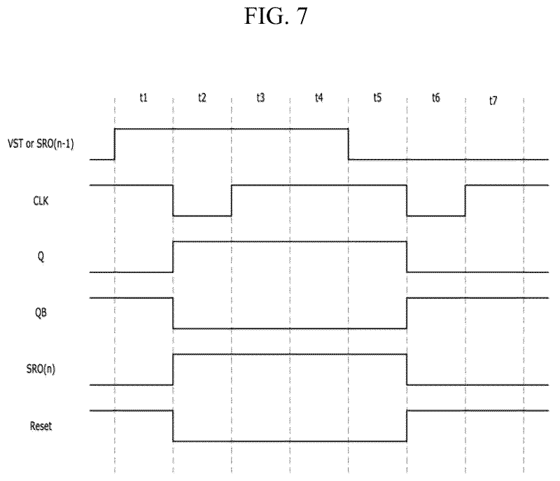

FIG. 7 is a waveform diagram of the emission driver in the gate driving circuit of the display device according to the other aspect of the present disclosure.

The reset signal Reset may be a signal that is opposite in phase with respect to the start signal VST and is delayed by a predetermined period of time t1 with respect to the start signal VST.

As shown in FIG. 7, in a first period t1 in which the level of the start signal VST or the output signal SRO(n−1) of the previous stage is high, the level of the clock signal CLK is high, and the level of the reset signal Reset is high, the first transistor T13 and the second transistor T14 may be turned off, and the third and fourth transistors T15 and T16 may be turned on because the node Q1 and the node Q2 are maintained at a low level in a previous step.

Accordingly, the set node Q may maintain a low voltage, which is a low level, and the gate high voltage VGH may be provided to the reset node QB. In this case, because the first reset transistor T17 is turned off, the gate high voltage VGH may not be applied to the node Q2.

Therefore, the first output transistor T11 may be turned on, and the second output transistor T12 may be turned off, whereby the gate low voltage VGL may be output to the output terminal SRO(n). In some cases, the output terminal SRO (n) is coupled to a gate line GL and an input of a next gate driver SRO(n+1).

In a second period t2 in which the start signal GVST or the output signal SRO(n−1) of the previous stage is maintained at a high level and the clock signal CLK and the reset signal Reset transition to a low level, the first transistor T13 and the third transistor T15 may be turned on, and the second transistor T14 and the fourth transistor T16 may be turned off.

Accordingly, the Q2 node Q2 and the set node Q may be charged with the high-level voltage of the start signal GVST or the output signal SRO(n−1) of the previous stage, and the reset node QB may be discharged to the low-level voltage of the clock signal CLK. In this case, because the first reset transistor T17 is turned on, the gate high voltage VGH may be provided to the Q2 node Q2 through the first reset transistor T17.

Therefore, the first output transistor T11 may be turned off, and the second output transistor T12 may be turned on, whereby the gate high voltage VGH may be output to the output terminal SRO(n).

In third and fourth periods t3 and t4 in which the level of the start signal GVST or the output signal SRO(n−1) of the previous stage is high, the clock signal CLK transitions to a high level, and the reset signal Reset is maintained at a low level, the first transistor T13, the second transistor T14, and the fourth transistor T16 may be turned off, and the third transistor T15 may remain in the turned-on state, whereby the Q2 node Q2 and the may maintain the high-level voltage of the start signal GVST or the output signal SRO(n−1) of the previous stage, and the reset node QB may maintain the low-level voltage of the clock signal CLK. In this case, the gate high voltage VGH may be provided to the Q2 node Q2 through the first reset transistor T17.

Therefore, the first output transistor T11 may be turned off, and the second output transistor T12 may be turned on, whereby the gate high voltage VGH may be output to the output terminal SRO(n).

In a fifth period t5 in which the start signal GVST or the output signal SRO(n−1) of the previous stage transitions to a low level, the clock signal CLK is maintained at a high level, and the reset signal Reset is maintained at a low level, the first transistor T13, the third transistor T15, and the fourth transistor T16 may remain in the turned-off state, and the second transistor T14 may be turned on.

Accordingly, the Q2 node Q2 and the set node Q may maintain the high-level voltage of the start signal GVST or the output signal SRO(n−1) of the previous stage, and the reset node QB may maintain the low-level voltage of the clock signal CLK. In this case, the gate high voltage VGH may be provided to the Q2 node Q2 through the first reset transistor T17.

Therefore, the first output transistor T11 may be turned off, and the second output transistor T12 may be turned on, whereby the gate high voltage VGH may be output to the output terminal SRO(n).

In a sixth period t6 in which the start signal GVST or the output signal SRO(n−1) of the previous stage is maintained at a low level, the clock signal CLK transitions to a low level, and the reset signal Reset transitions to a high level, the first transistor T13, the second transistor T14, and the fourth transistor T16 may be turned on, and the third transistor T15 may be turned off.

Accordingly, the Q2 node Q2 and the set node Q may transition to the low-level voltage of the start signal GVST or the output signal SRO(n−1) of the previous stage, and the gate high voltage VGH may be applied to the reset node QB. In this case, because the first reset transistor T17 is turned off, the gate high voltage VGH may not be provided to the Q2 node Q2 through the first reset transistor T17.

Therefore, the first output transistor T11 may be turned on, and the second output transistor T12 may be turned off, whereby the gate low voltage VGL may be output to the output terminal SRO(n).

In a seventh period t7 in which the start signal GVST or the output signal SRO(n−1) of the previous stage is maintained at a low level, the clock signal CLK transitions to a high level, and the reset signal Reset is maintained at a high level, the first transistor T13 and the third transistor T15 may be turned off, and the second transistor T14 and the fourth transistor T16 may remain in the turned-on state.

Accordingly, the Q2 node Q2 and the set node may maintain the low-level voltage of the start signal GVST or the output signal SRO(n−1) of the previous stage, and the reset node QB may maintain the gate high voltage VGH. In this case, because the first reset transistor T17 is turned off, the gate high voltage VGH may not be provided to the Q2 node Q2 through the first reset transistor T17.

Therefore, the first output transistor T11 may be turned on, and the second output transistor T12 may be turned off, whereby the gate low voltage VGL may be output to the output terminal SRO(n).

The gate driving circuit according to the other aspect of the present disclosure uses the reset signal Reset to enhance the unstable voltage of the set node in abnormal on/off situations while maintaining the gate driving circuit shown in FIG. 4.

Even if the set node Q becomes unstable in an abnormal on/off situation, the first reset transistor may supply the gate high voltage to the set node Q using the reset signal Reset. Therefore, the gate driving circuit according to the other aspect of the present disclosure may secure stable output of the scan signal or the emission signal even in abnormal on/off situations.

Since the second reset transistor is connected between the set node and the gate node of the fourth transistor, the set node and the gate node of the fourth transistor may be controlled to be equipotential. Therefore, it may be possible to prevent occurrence of a ripple in the set node.

Even in abnormal on/off situations, stable output of the scan signal or the emission signal may be secured using a minimum number of transistors, and thus a narrow bezel may be implemented.

The display device according to various aspects of the present disclosure may be applied to mobile apparatuses, video phones, smart watches, watch phones, wearable apparatuses, foldable apparatuses, rollable apparatuses, bendable apparatuses, flexible apparatuses, curved apparatuses, sliding apparatuses, variable apparatuses, electronic organizers, electronic books, portable multimedia players (PMPs), personal digital assistants (PDAs), MP3 players, mobile medical devices, desktop personal computers (PCs), laptop PCS, netbook computers, workstations, navigation apparatuses, automotive navigation apparatuses, automotive display apparatuses, automotive apparatuses, theater apparatuses, theater display apparatuses, TVs, wallpaper display apparatuses, signage apparatuses, game machines, notebook computers, monitors, cameras, camcorders, home appliances, etc.

A gate driving circuit and a display device including the same according to various aspects of the present disclosure may be described as follows.

A gate driving circuit according to various aspects of the present disclosure may include a first controller configured to control the voltage of a set node, a second controller configured to control the voltage of a reset node, a first output transistor connected to the set node, and a second output transistor connected to the reset node.

According to various aspects of the present disclosure, the first output transistor may be connected between a gate low voltage line and an output terminal.

According to various aspects of the present disclosure, the second output transistor may be connected between a gate high voltage line and the output terminal.

According to various aspects of the present disclosure, the first controller may include a first transistor connected to a node Q2 and a transfer transistor connected between the set node Q and the node Q2.

According to various aspects of the present disclosure, the first controller may control the voltage of the set node in response to a clock signal and a start signal or an output signal of a previous stage. The first transistor may provide the start signal or the output signal of the previous stage to the node Q2 in response to the clock signal. The transfer transistor may transfer the voltage of the node Q2 to the set node Q in response to a gate low voltage.

According to various aspects of the present disclosure, the second controller may include a second transistor connected to a Q1 node, a third transistor connected between the QB node and a clock signal line, and a fourth transistor connected between the QB node and the gate high voltage line.

According to various aspects of the present disclosure, the second controller may control the voltage of the QB node in response to the clock signal and the start signal or the output signal of the previous stage. The second transistor may provide a gate high voltage to the Q1 node in response to the voltage of the start signal or the output signal of the previous stage. The third transistor may provide the clock signal to the QB node in response to the voltage of the node Q1. The fourth transistor may provide the gate high voltage to the reset node Qb in response to the voltage of the node Q2 or the set node Q.

According to various aspects of the present disclosure, one of the first output transistor, the second output transistor, the transfer transistor, and the first to fourth transistors may include one of an oxide semiconductor layer and a low-temperature polysilicon semiconductor layer or a combination thereof.

According to various aspects of the present disclosure, the gate driving circuit may further include a first capacitor located between the set node Q and the output terminal, a second capacitor located between the reset node QB and the gate high voltage line, and a third capacitor located between the node Q1 and the clock signal line.

A gate driving circuit according to various aspects of the present disclosure may include a first controller configured to control the voltage of a set node, a second controller configured to control the voltage of a reset node, a first reset transistor connected between a gate high voltage line and a node Q2, a first output transistor connected to the set node Q, and a second output transistor connected to the reset node.

According to various aspects of the present disclosure, the first reset transistor may provide a gate high voltage to the set node Q in response to a reset signal.

According to various aspects of the present disclosure, the reset signal may be opposite in phase with respect to a start signal. The reset signal may be a signal delayed by a predetermined period of time with respect to the start signal.

According to various aspects of the present disclosure, the first output transistor may be connected between a gate low voltage line and an output terminal.

According to various aspects of the present disclosure, the second output transistor may be connected between the gate high voltage line and the output terminal.

According to various aspects of the present disclosure, the first controller may include a first transistor connected to a Q2 node and a transfer transistor connected between the set node Q and the node Q2.

According to various aspects of the present disclosure, the first controller may control the voltage of the set node Q in response to a clock signal and a start signal or an output signal of a previous stage. The first transistor may provide the start signal or the output signal of the previous stage to the node Q2 in response to the clock signal. The transfer transistor may transfer the voltage of the node Q2 to the set node Q in response to a gate low voltage.

According to various aspects of the present disclosure, the second controller may include a second transistor connected to a Q1 node, a third transistor connected between the QB node and a clock signal line, and a fourth transistor connected between the QB node and the gate high voltage line.

According to various aspects of the present disclosure, the second controller may control the voltage of the QB node in response to the clock signal and the start signal or the output signal of the previous stage. The second transistor may provide a gate high voltage to the Q1 node in response to the voltage of the start signal or the output signal of the previous stage. The third transistor may provide the clock signal to the QB node in response to the voltage of the node Q1. The fourth transistor may provide the gate high voltage to the reset node QB in response to the voltage of the node Q2 or the set node Q.

According to various aspects of the present disclosure, the gate driving circuit may further include a first capacitor located between the set node Q and the output terminal, a second capacitor located between the reset node QB and the gate high voltage line, and a third capacitor located between the node Q1 and the clock signal line.

According to various aspects of the present disclosure, the gate driving circuit may further include a second reset transistor connecting the set node Q to a gate node of the fourth transistor.

According to various aspects of the present disclosure, the second reset transistor may connect the set node Q to the gate node of the fourth transistor in response to a gate low voltage.

According to various aspects of the present disclosure, one of the first output transistor, the second output transistor, the transfer transistor, the first to fourth transistors, the first reset transistor, and the second reset transistor may include one of an oxide semiconductor layer and a low-temperature polysilicon semiconductor layer or a combination thereof.

A display device according to various aspects of the present disclosure may include a display panel including a plurality of data lines, a plurality of gate lines, and a plurality of pixels, a gate driving circuit connected to the plurality of gate lines, and a data driving circuit connected to the plurality of data lines.

According to various aspects of the present disclosure, each of the plurality of pixels may include a driving transistor, a switching transistor, and a light-emitting diode. One of the driving transistor and the switching transistor may include one of an oxide semiconductor layer and a low-temperature polysilicon semiconductor layer.

According to various aspects of the present disclosure, the display device may further include an encapsulation member located on the light-emitting diode and a touch unit located on the encapsulation member.

As is apparent from the above description, according to the present disclosure, a gate driving circuit according to an aspect may maintain the function and circuit of an emission control generator, and may implement variable frequency driving.

According to the present disclosure, even when an abnormal on/off situation occurs and thus the voltage of a set node is unstable, malfunction of the gate driving circuit may be prevented using a reset signal.

According to the present disclosure, since malfunction of the gate driving circuit is prevented using a minimum number of transistors, a narrow bezel may be implemented.

According to the present disclosure, since malfunction of the gate driving circuit due to unstable voltage of the set node is prevented, the defect rate of a display device may be reduced. Therefore, the amount of energy consumed to produce the display device may be reduced, and the amount of greenhouse gases generated during a manufacturing process may be reduced. As a result, the present disclosure has environment/social/governance (ESG) effects.

Those skilled in the art will understand that various modifications and alternative configurations are possible from the above description without departing from the technical idea of the present disclosure. Consequently, the technical scope of the present disclosure is defined by the appended claims, not by the detailed description of the present disclosure.

1. A gate driving circuit comprising:
a first controller configured to control a voltage of a set node;
a second controller configured to control a voltage of a reset node;
a first output transistor connected to the set node; and
a second output transistor connected to the reset node.

2. The gate driving circuit according to claim 1, wherein the first output transistor is connected between a gate low voltage line and an output terminal.

3. The gate driving circuit according to claim 1, wherein the second output transistor is connected between a gate high voltage line and an output terminal.

4. The gate driving circuit according to claim 1, wherein the first controller comprises:
a first transistor connected to a second node; and
a transfer transistor connected between the set node and the second node.

5. The gate driving circuit according to claim 4, wherein the first controller controls the voltage of the set node in response to a clock signal and a start signal or an output signal of a previous stage,
wherein the first transistor provides the start signal or the output signal of the previous stage to the second node in response to the clock signal, and
wherein the transfer transistor transfers a voltage of the second node to the set node in response to a gate low voltage.

6. The gate driving circuit according to claim 4, wherein the second controller comprises:
a second transistor connected to a first node;
a third transistor connected between the reset node and a clock signal line; and
a fourth transistor connected between the reset node and a gate high voltage line.

7. The gate driving circuit according to claim 6, wherein the second controller controls the voltage of the reset node in response to a clock signal and a start signal or an output signal of a previous stage,
wherein the second transistor provides a gate high voltage to the first node in response to a voltage of the start signal or the output signal of the previous stage,
wherein the third transistor provides the clock signal to the reset node in response to a voltage of the first node, and
wherein the fourth transistor provides the gate high voltage to the reset node in response to a voltage of the second node or the set node.

8. The gate driving circuit according to claim 6, wherein one of the first output transistor, the second output transistor, the transfer transistor, and the first to fourth transistors comprises one of an oxide semiconductor layer and a low-temperature polysilicon semiconductor layer or a combination thereof.

9. The gate driving circuit according to claim 6, further comprising:
a first capacitor located between the set node and an output terminal;
a second capacitor located between the reset node and the gate high voltage line; and
a third capacitor located between the first node and the clock signal line.

10. A gate driving circuit comprising:
a first controller configured to control a voltage of a set node;
a second controller configured to control a voltage of a reset node;
a first reset transistor connected between a gate high voltage line and a second node;
a first output transistor connected to the set node; and
a second output transistor connected to the reset node.

11. The gate driving circuit according to claim 10, wherein the first reset transistor provides a gate high voltage to the set node in response to a reset signal.

12. The gate driving circuit according to claim 11, wherein the reset signal is a signal opposite in phase with respect to a start signal and delayed by a predetermined period of time with respect to the start signal.

13. The gate driving circuit according to claim 10, wherein the first output transistor is connected between a gate low voltage line and an output terminal.

14. The gate driving circuit according to claim 10, wherein the second output transistor is connected between the gate high voltage line and an output terminal.

15. The gate driving circuit according to claim 10, wherein the first controller comprises:
a first transistor connected to the second Q2 node; and
a transfer transistor connected between the set node and the second node.

16. The gate driving circuit according to claim 15, wherein the first controller controls the voltage of the set node in response to a clock signal and a start signal or an output signal of a previous stage,
wherein the first transistor provides the start signal or the output signal of the previous stage to the second node in response to the clock signal, and
wherein the transfer transistor transfers a voltage of the second node to the set node in response to a gate low voltage.

17. The gate driving circuit according to claim 15, wherein the second controller comprises:
a second transistor connected to a first node;
a third transistor connected between the reset node and a clock signal line; and
a fourth transistor connected between the reset node and the gate high voltage line.

18. The gate driving circuit according to claim 17, wherein the second controller controls the voltage of the reset node in response to a clock signal and a start signal or an output signal of a previous stage,
wherein the second transistor provides a gate high voltage to the first node in response to a voltage of the start signal or the output signal of the previous stage,
wherein the third transistor provides the clock signal to the reset node in response to a voltage of the first node, and
wherein the fourth transistor provides the gate high voltage to the reset node in response to a voltage of the second node or the set node.

19. The gate driving circuit according to claim 17, further comprising:
a first capacitor located between the set node and an output terminal;
a second capacitor located between the reset node and the gate high voltage line; and
a third capacitor located between the first node and the clock signal line.

20. The gate driving circuit according to claim 17, further comprising a second reset transistor connecting the set node to a gate node of the fourth transistor.

21. The gate driving circuit according to claim 20, wherein the second reset transistor connects the set node to the gate node of the fourth transistor in response to a gate low voltage.

22. The gate driving circuit according to claim 20, wherein one of the first output transistor, the second output transistor, the transfer transistor, the first to fourth transistors, the first reset transistor, and the second reset transistor comprises one of an oxide semiconductor layer and a low-temperature polysilicon semiconductor layer or a combination thereof.

23. A display device comprising:
a display panel including a plurality of data lines, a plurality of gate lines, and a plurality of pixels;
a gate driving circuit connected to the plurality of gate lines; and
a data driving circuit connected to the plurality of data lines,
wherein the gate driving circuit comprises:
a first controller configured to control a voltage of a set node;
a second controller configured to control a voltage of a reset node;
a first output transistor connected to the set node; and
a second output transistor connected to the reset node, and
wherein the gate driving circuit receives a start signal, delays the start signal by a time delay, and outputs a delayed start signal to a second gate driving circuit.

24. The display device according to claim 23, wherein each of the plurality of pixels comprises a driving transistor, a switching transistor, and a light-emitting diode, and
wherein one of the driving transistor and the switching transistor comprises one of an oxide semiconductor layer and a low-temperature polysilicon semiconductor layer.

25. The display device according to claim 24, further comprising:
an encapsulation member located on the light-emitting diode; and
a touch unit located on the encapsulation member.

26. The display device according to claim 23, further comprising a first reset transistor connected between a gate high voltage line and a second node.

27. The display device according to claim 26, wherein the first reset transistor is configured to receive a reset signal and stabilize the voltage of the voltage of the set node when switching the display device from a first frame rate to a second frame rate.

28. The display device according to claim 27, wherein the reset signal is inversely correlated with the start signal based on a delay.

29. The display device according to claim 27, further comprising a single clock coupled to the first controller and the second controller, wherein a clock signal of the clock is configured to activate the first controller and the second controller in conjunction with the reset signal.
